(19) United States
(12) Patent Application Publication
(10) Pub. No.: US 2022/0281471 A1
(43) Pub. Date: Sep. 8, 2022

(54) INFORMATION NOTIFYING DEVICE, CONTROL DEVICE, AND NON-TRANSITORY COMPUTER-READABLE MEDIUM

(71) Applicant: KABUSHIKI KAISHA TOKAI RIKA DENKI SEISAKUSHO, Aichi (JP)

(72) Inventors: Shuhei TAKEUCHI, Aichi (JP); Aya KADONO, Aichi (JP); Takashi SUZUKI, Aichi (JP)

(73) Assignee: KABUSHIKI KAISHA TOKAI RIKA DENKI SEISAKUSHO, Aichi (JP)

(21) Appl. No.: 17/632,661

(22) PCT Filed: Aug. 5, 2020
(86) PCT No.: PCT/JP2020/030038

§ 371 Date: Feb. 3, 2022

(30) Foreign Application Priority Data
Aug. 21, 2019 (JP) 2019-151132

(51) Int. Cl. B60W 50/16; B60W 40/08; B60N 2/56; G08B 21/06

(52) U.S. Cl. CPC B60W 50/16; B60W 40/08; B60N 2/56; G08B 21/06; B60W 2040/0827; B60W 2540/229

(57) ABSTRACT

A tactile presenting device presents at least one of an electrical stimulus, a warm sensation, and a cold sensation at an object adapted to contact a portion of a body of an occupant of a mobile entity. A control device outputs a control signal for causing the tactile presenting device to present at least one of the electrical stimulus, the warm sensation, and the cold sensation in a case where a prescribed condition as to a traveling environment of the mobile entity is satisfied.

### FIELD

The presently disclosed subject matter relates to an information notifying device adapted to be installed in a mobile entity. The presently disclosed subject matter also relates to a control device adapted to be installed in a mobile entity for controlling a tactile presenting device configured to present at least one of an electrical stimulus, a warm sensation, and a cold sensation at a member adapted to contact a portion of a body of an occupant of the mobile entity, as well as a non-transitory computer-readable medium having stored a computer program adapted to be executed by a processor of the control device.

### BACKGROUND

Japanese Patent Publication No. 2019-096368A discloses a technique for performing a traveling support by notifying an occupant that a traveling environment of a mobile entity satisfies a specific condition.

As used herein, the term “traveling environment” is used comprehensively to mean a state of an external environment of a mobile entity, a state of the mobile entity itself, and a state of an occupant of the mobile entity.

### SUMMARY

### Technical Problem

It is demanded to make it possible to notify an occupant of information as to the traveling environment of a mobile entity with higher reliably.

### Solution to Problem

In order to meet the demand described above, an illustrative aspect of the presently disclosed subject matter provides an information notifying device adapted to be installed in a mobile entity, comprising:

a tactile presenting device configured to present at least one of an electrical stimulus, a warm sensation, and a cold sensation at a member adapted to contact a portion of a body of an occupant of the mobile entity; and

a control device configured to output a control signal for causing the tactile presenting device to present at least one of the electrical stimulus, the warm sensation, and the cold sensation in a case where a prescribed condition as to a traveling environment of the mobile entity is satisfied.

In order to meet the demand described above, an illustrative aspect of the presently disclosed subject matter provides a control device adapted to be installed in a mobile entity to control a tactile presenting device configured to present at least one of an electrical stimulus, a warm sensation, and a cold sensation at a member adapted to contact a portion of a body of an occupant of the mobile entity, the control device comprising:

an input interface configured to receive information as to a traveling environment of the mobile entity;

a processor configured to generate a control signal for causing the tactile presenting device to present at least one of the electrical stimulus, the warm sensation, and the cold sensation in a case where a prescribed condition as to the traveling environment of the mobile entity is satisfied; and

an output interface configured to output the control signal.

In order to meet the demand described above, an illustrative aspect of the presently disclosed subject matter provides a non-transitory computer-readable medium having stored a computer program to be executed by a control device adapted to be installed in a mobile entity to control a tactile presenting device configured to present at least one of an electrical stimulus, a warm sensation, and a cold sensation at a member adapted to contact a portion of a body of an occupant of the mobile entity, the computer program being configured to, when executed, cause the control device to:

determine whether a prescribed condition as to a traveling environment of the mobile entity is satisfied; and

output a control signal for causing the tactile presenting device to present at least one of the electrical stimulus, the warm sensation, and the cold sensation in a case where it is determined that the prescribed condition is satisfied.

According to the above configuration, by presenting a tactile to the body of the occupant contacting the member, it is possible to notify the fact that the traveling environment of the mobile entity satisfies the prescribed condition. Much of the visual sense and auditory sense of the occupant during the traveling are assigned to acquire other information. Since at least one of the electrical stimulus, the warm sensation, and the cold sensation is perceived by the occupant through a nerve path different from the visual sense and the auditory sense, it is possible to enhance a relative unexpectedness of the stimulus. As a result, it is possible to notify the occupant of information as to the traveling environment of the mobile entity with higher reliability.

### BRIEF DESCRIPTION OF DRAWINGS

FIG. 1 illustrates a functional configuration of an information notifying device according to an embodiment.

FIG. 2 illustrates a vehicle in which the information notifying device of FIG. 1 is to be installed.

FIG. 3 illustrates a configuration of a tactile presenting device of FIG. 1.

FIG. 4 illustrates a comparative example for explaining an operation of the information notifying device of FIG. 1.

FIG. 5 illustrates a comparative example for explaining an operation of the information notifying device of FIG. 1.

### DESCRIPTION OF EMBODIMENTS

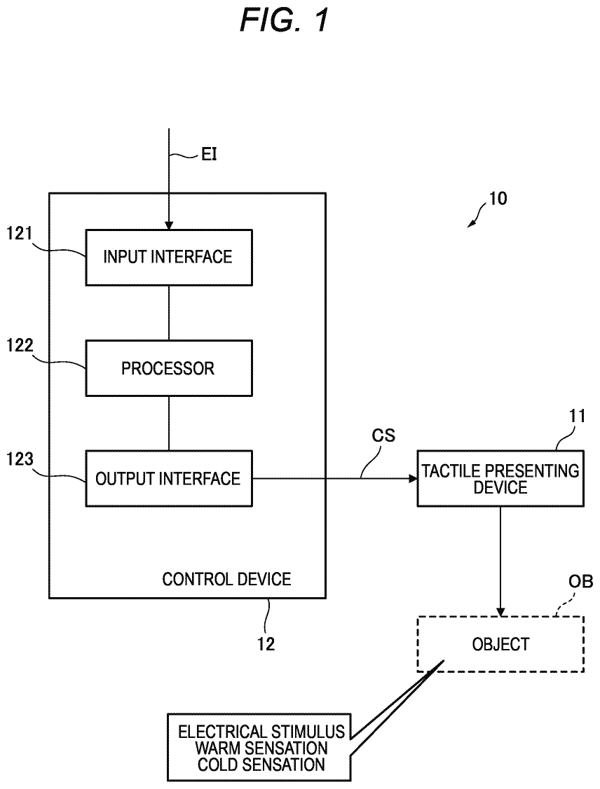

Exemplary embodiments will be described in detail below with reference to the accompanying drawings. FIG. 1 illustrates a functional configuration of an information notifying device 10 according to an embodiment.

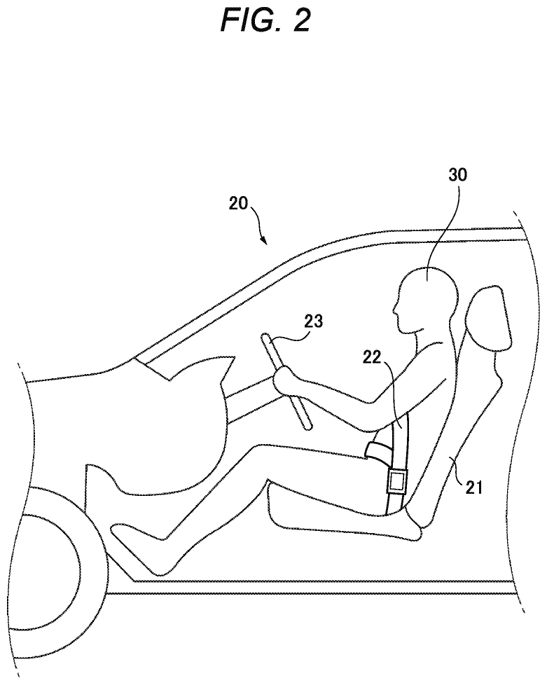

The information notifying device 10 is installed in a vehicle 20 as illustrated in FIG. 2. The vehicle 20 is an example of a mobile entity. In FIG. 2, a state that a driver 30 is seated on a seat 21 is illustrated. The driver 30 is an example of an occupant of the mobile entity. The driver 30 wears a seat belt 22. The driver 30 grips a steering wheel 23.

As illustrated in FIG. 1, the information notifying device 10 includes a tactile presenting device 11 and a control device 12.

The tactile presenting device 11 is a device configured to present at least one of an electrical stimulus, a warm sensation, and a cold sensation at an object OB. The object OB is a member adapted to be contact a portion of a body of the driver 30. Each of the seat 21, the seat belt 22, and the steering wheel 23 in FIG. 2 is an example of the object OB. A head rest or an arm rest may also be an example of the object OB.

The electrical stimulus is provided through an electrode formed on the surface of the object OB. For example, a current of 2-5 mA is supplied through the electrode in order to cause the driver 30 to perceive the electrical stimulus without causing pain. Namely, the device for supplying current through the electrode is an example of the tactile presenting device 11.

The warm sensation is provided by causing the surface temperature of the object OB to be higher than ambient temperature. The warm sensation can be provided through an operation of a heater or the like. Namely, the heater and a device for controlling the operation thereof are an example of the tactile presenting device 11.

The cold sensation is provided by causing the surface temperature of the object OB to be lower than the ambient temperature. The cold sensation may be provided through an operation of a Peltier element or the like. Namely, the Peltier element and a device for controlling the operation thereof are an example of the tactile presenting device 11.

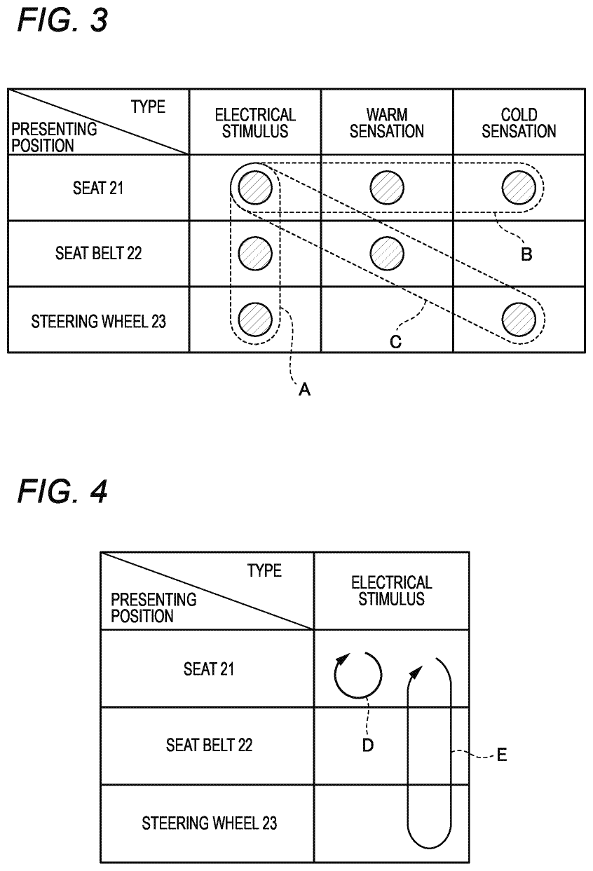

The relationship between the type of tactile to be presented and the position at which the tactile is to be presented can be arbitrarily determined. FIG. 3 illustrates a table showing examples of possible combinations.

The pattern A includes possible combinations arranged in the up-down direction of the table. It is illustrated an example wherein each of the seat 21, the seat belt 22, and the steering wheel 23 presents an electrical stimulus. In other words, any possible combinations wherein the same kind of tactile is presented from each of different kinds of objects OB may be included in the pattern A. For example, combinations wherein a warm sensation is presented from each of the seat belt 22 and the steering wheel 23 may be included in the pattern A.

The pattern B includes possible combinations arranged in the left-right direction of the table. It is illustrated an example wherein all of the electrical stimulus, the warm sensation, and the cold sensation are presented from the seat 21. In other words, any possible combinations wherein different kinds of tactiles are presented from the same object OB may be included in the pattern B. For example, combinations wherein a warm sensation and a cold sensation are presented from the steering wheel 23 may be included in the pattern B.

The pattern C includes possible combinations arranged in neither the up-down direction nor the left-right direction of the table. It is illustrated an example wherein an electrical stimulus is presented from the seat 21, a warm sensation is presented from the seat belt 22, and a cold sensation is presented from the steering wheel 23. In other words, any possible combinations wherein different kinds of tactiles are presented from different kinds of objects OB may be included in the pattern C. For example, combinations wherein a cold sensation is presented from the seat belt 22 and an electrical stimulus is presented from the steering wheel 23 may be included in the pattern C.

The tactile presenting device 11 defines a relationship between the type of tactile to be presented and the position at which the tactile is to be presented based on at least one of the pattern A, the pattern B, and the pattern C.

The control device 12 is a device configured to control the tactile presenting device 11. As illustrated in FIG. 1, the control device 12 includes an input interface 121, a processor 122, and an output interface 123.

The input interface 121 is configured to receive environment information EI of the vehicle 20. The environment information EI is information indicating the traveling environment of the vehicle 20. In other words, the environment information EI includes at least one of information indicating a state of the external environment of the vehicle 20, information indicating a state of the vehicle 20, and information indicating a state of the driver 30. The environment information EI is generated based on information acquired by various sensors and/or a control device installed in the vehicle 20.

Examples of the information indicating the state of the external environment of the vehicle 20 include weather information, traffic information, inter-vehicle distance information, obstacle information, and road surface information.

Examples of the information indicating the state of the vehicle 20 include information indicating the speed, information indicating the acceleration, information indicating the traveling direction, information indicating the lighting state of the lighting device, information indicating the state of the parking brake, information indicating the locked state of the door, information indicating the engine temperature, and information indicating the air pressure of the tire.

Examples of the information indicating the state of the driver 30 include information indicating an awakening degree, information indicating that the seat belt is not worn, and information indicating the lookaside state.

The environment information EI may be in the form of analog data or digital data. When the environment information EI is in the form of analog data, the input interface 121 includes an appropriate conversion circuit including an A/D converter.

The processor 122 is configured to determine whether a prescribed condition as to the traveling environment of the vehicle 20 is satisfied based on the environment information EI. The prescribed condition is set by using at least one of information indicating the state of the external environment of the vehicle 20, information indicating the state of the vehicle 20, and information indicating the state of the driver 30 in order to notify such a traveling environment that the driver 30 needs to be alerted. Examples of the prescribed condition include the following conditions.

The headlight is not turned on even though the visibility is poor due to a decrease in illumination intensity or bad weather.

The statutory speed is exceeded.

The inter-vehicle distance with respect to a forward vehicle is less than a threshold.

The engine was stopped under a condition that the parking brake is inactive.

The awakening degree of the driver is less than a threshold.

The vehicle is traveling under a condition that the seat belt is not worn by the occupant.

The processor 122 may determine that a prescribed condition as to the traveling environment is satisfied based on a fact that the input interface 121 acquires the environment information EI indicating that the prescribed condition is satisfied.

When it is determined that the prescribed condition as to the traveling environment is satisfied, the processor 122 is configured to generate a control signal CS. The control signal CS is a signal for causing the tactile presenting device 11 to present at least one of an electrical stimulus, a warm sensation, and a cold sensation at the object OB.

The output interface 123 is configured to transmit the control signal CS as generated to the tactile presenting device 11. The tactile presenting device 11 having received the control signal CS presents at least one of an electrical stimulus, a warm sensation, and a cold sensation corresponding to the control signal CS at the object OB. The control signal CS may be an analog signal or a digital signal. In a case where the control signal CS is the analog signal, the output interface 123 includes an appropriate conversion circuit including a D/A converter.

According to such a configuration, by presenting a tactile to the body of the driver 30 contacting the object OB, it is possible to notify the fact that the traveling environment of the vehicle 20 satisfies the prescribed condition. Much of the visual sense and auditory sense of the driver 30 during the driving are assigned to acquire other information. Since at least one of the electrical stimulus, the warm sensation, and the cold sensation is perceived by the driver 30 through a nerve path different from the visual sense and the auditory sense, it is possible to enhance a relative unexpectedness of the stimulus. As a result, it is possible to notify the driver 30 of information as to the traveling environment of the vehicle 20 with higher reliability. In particular, when it is notified that the awakening degree of the driver 30 is less than the threshold, the unexpectedness of the stimulus as described above may contribute to the recovery of the awakening degree.

The processor 122 may generate the control signal CS such that the position at which at least one of the electrical stimulus, the warm sensation, and the cold sensation is presented is determined with irregularity. In other words, the control signal CS is generated such that the relationship between the fact that a specific condition as to the traveling environment is satisfied and the object OB used for presenting a tactile for notifying the fact has irregularity. Specifically, the processor 122 determines an object OB presenting a tactile through the use of a random number table or the like, and generates a control signal CS so as to designate the object OB as determined.

As illustrated in FIG. 4, assuming a case where an electrical stimulus is presented when the awakening degree of the driver 30 is less than the threshold while the electrical stimulus can be presented from each of the seat 21, the seat belt 22, and the steering wheel 23. The pattern D represents an example wherein the electrical stimulus is always presented from the seat 21. The pattern E represents an example wherein the position at which the electrical stimulus is presented is cyclically changed in the order of the seat 21, the seat belt 22, and the steering wheel 23. In either pattern, while the tactile presentations are repeated, the driver 30 can get predictability for the position at which a tactile is presented next time.

On the other hand, by generating the control signal CS so as to involve the irregularity as to the tactile presenting position, the electrical stimulus is irregularly presented from any one of the seat 21, the seat belt 22, and the steering wheel 23. According to such a configuration, the driver 30 gets difficulty to predict the position at which a tactile is presented next time. As a result, it is made easier to maintain the unexpectedness of the stimulus described above.

Additionally or alternatively, the processor 122 may generate the control signal CS such that a timing at which at least one of the electrical stimulus, the warm sensation, and the cold sensation is presented is determined with irregularity. Specifically, the processor 122 determines a time interval between the repetitive tactile presentations through the use of a random number table or the like, and generates the control signal CS so as to designate the time interval as determined.

As an example, assuming a case where electrical stimuli are repeatedly presented from the seat 21 when the awakening degree of the driver 30 is less than a threshold. In a case where the time interval between the repetitive electrical stimuli is constant, while the tactile presentations are repeated, the driver 30 can get predictability for the timing at which a tactile is presented next time.

On the other hand, by generating the control signal CS so as to involve the irregularity as to the timing for the tactile presentation, the time interval between the repetitive electrical stimuli from the seat 21 can be made irregular. According to such a configuration, the driver 30 gets difficulty to predict the timing at which a tactile is presented next time. As a result, it is made easier to maintain the unexpectedness of the stimulus described above.

Additionally or alternatively, the processor 122 may generate the control signal CS such that an order in which at least two of the electrical stimulus, the warm sensation, and the cold sensation are presented is determined with irregularity. In other words, the control signal CS is generated such that the relationship between the fact that a specific condition as to the traveling environment is satisfied and the types of tactiles used for notifying the fact has irregularity. Specifically, the processor 122 determines the types of tactiles to be presented through the use of a random number table or the like, and generates the control signal CS so as to designate the types of tactiles as determined.

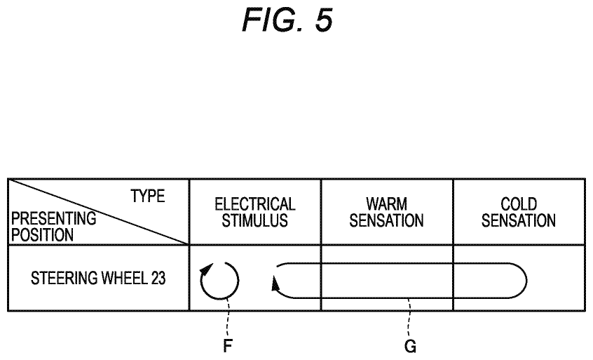

As illustrated in FIG. 5, assuming a case where a tactile can be presented from the steering wheel 23 when the awakening degree of the driver 30 is less than a threshold. The pattern F represents an example wherein the electrical stimulus is always presented. The pattern G represents an example wherein the type of tactile to be presented is cyclically changed in the order of the electrical stimulus, the warm sensation, and the cold sensation. In either pattern, while the tactile presentations are repeated, the driver 30 can get predictability for the type of tactile to be presented next time.

On the other hand, by generating the control signal CS so as to involve the irregularity as to the order for the type of tactile to be presented, any one of the electrical stimulus, the warm sensation, and the cold sensation is irregularly presented from the steering wheel 23. According to such a configuration, the driver 30 gets difficulty to predict the type of tactile to be presented next time. As a result, it is made easier to maintain the unexpectedness of the stimulus described above.

The processor 122 may generate the control signal CS by combining the irregularity as to the tactile presenting position described with reference to FIG. 4 and the irregularity as to the type of the tactile to be presented described with reference to FIG. 5. In this case, when a specific condition as to the traveling environment is satisfied, any one of the electrical stimulus, the warm sensation, and the cold sensation is irregularly presented from any one of the seat 21, the seat belt 22, and the steering wheel 23. According to such a configuration, the driver 30 gets further difficulty to predict the position and the type of tactile to be presented next time. As a result, it is made easier to maintain the unexpectedness of the stimulus described above with a higher extent.

Each function of the processor 122 described above can be implemented by a general-purpose microprocessor operating in cooperation with a general-purpose memory. Examples of the general-purpose microprocessor include a CPU, an MPU, and a GPU. Examples of the general-purpose memory include a ROM and a RAM. In this case, a computer program for executing the above-described processing can be stored in the ROM. The ROM is an example of a non-transitory computer-readable medium having stored a computer program. The processor 122 designates at least a part of the program stored in the ROM, loads the program on the RAM, and executes the processing described above in cooperation with the RAM. The above-described computer program may be pre-installed in a general-purpose memory, or may be downloaded from an external server device via a communication network and then installed in the general-purpose memory. In this case, the external server device is an example of the non-transitory computer-readable medium.

Each function of the processor 122 may be implemented by an exclusive integrated circuit such as a microcontroller, an ASIC, and an FPGA capable of executing the above-described computer program. In this case, the above-described computer program is pre-installed in a memory element included in the exclusive integrated circuit. The memory element is an example of the non-transitory computer-readable medium. Each function of the processor 122 may be implemented by a combination of the general-purpose microprocessor and the exclusive integrated circuit.

The above embodiments are merely illustrative for facilitating understanding of the gist of the presently disclosed subject matter. The configuration according to each of the above embodiments can be appropriately modified or changed without departing from the gist of the presently disclosed subject matter.

The above-described information notifying device 10 can be installed in a mobile entity other than the vehicle 20 requiring the driver 30. For example, in a mobile entity used in an attraction in an amusement facility, in accordance with the occurrence of a prescribed event in the attraction, the above-described tactile can be presented through a member adapted to contact the body of the occupant. In this case, the occurrence of the prescribed event is an example of the traveling environment of the mobile entity.

The present application is based on Japanese Patent Application No. 2019-151132 filed on Aug. 21, 2019, the entire contents of which are incorporated herein by reference.

1. An information notifying device adapted to be installed in a mobile entity, comprising:
a tactile presenting device configured to present at least one of an electrical stimulus, a warm sensation, and a cold sensation at a member adapted to contact a portion of a body of an occupant of the mobile entity; and
a control device configured to output a control signal for causing the tactile presenting device to present at least one of the electrical stimulus, the warm sensation, and the cold sensation in a case where a prescribed condition as to a traveling environment of the mobile entity is satisfied.

2. The information notifying device according to claim 1,
wherein the prescribed condition includes a case where an awakening degree of the occupant is less than a threshold.

3. The information notifying device according to claim 1,
wherein the control device is configured to generate the control signal such that irregularity is involved in at least one of a position and a timing at which at least one of the electrical stimulus, the warm sensation, and the cold sensation is to be presented.

4. The information notifying device according to claim 1,
wherein the control device is configured to generate the control signal such that irregularity is involved in an order in which at least two of the electrical stimulus, the warm sensation, and the cold sensation are presented.

5. A control device adapted to be installed in a mobile entity to control a tactile presenting device configured to present at least one of an electrical stimulus, a warm sensation, and a cold sensation at a member adapted to contact a portion of a body of an occupant of the mobile entity, the control device comprising:
an input interface configured to receive information as to a traveling environment of the mobile entity;
a processor configured to generate a control signal for causing the tactile presenting device to present at least one of the electrical stimulus, the warm sensation, and the cold sensation in a case where a prescribed condition as to the traveling environment of the mobile entity is satisfied; and
an output interface configured to output the control signal.

6. A non-transitory computer-readable medium having stored a computer program to be executed by a control device adapted to be installed in a mobile entity to control a tactile presenting device configured to present at least one of an electrical stimulus, a warm sensation, and a cold sensation at a member adapted to contact a portion of a body of an occupant of the mobile entity, the computer program being configured to, when executed, cause the control device to:
determine whether a prescribed condition as to a traveling environment of the mobile entity is satisfied; and
output a control signal for causing the tactile presenting device to present at least one of the electrical stimulus, the warm sensation, and the cold sensation in a case where it is determined that the prescribed condition is satisfied.
